(19) United States
(12) Patent Application Publication
(10) Pub. No.: US 2022/0046873 A1
(43) Pub. Date: Feb. 17, 2022

(54) AEROPONIC GROWING SYSTEM

(71) Applicant: Lusio Filiba, Austin, TX (US)

(72) Inventor: Lusio Filiba, Austin, TX (US)

(21) Appl. No.: 16/992,240

(22) Filed: Aug. 13, 2020

(51) Int. Cl. A01G 31/02; A47G 33/06

(52) U.S. Cl. CPC A01G 31/02; A01G 2031/006; A47G 33/06

(57) ABSTRACT

An aeroponic growing system having an overall non-rectilinear arboreal structure and appearance, and made of a reservoir base containing a reservoir for holding plant nutrient solution, at least one hose having a plurality of solution spray openings located thereon, one end of each of the at least one hose connected to one of a pump connected to the reservoir for holding plant nutrient solution, a plurality of growing baskets having both internal and external portions, a support structure comprising a plurality of growing basket openings, and sufficient internal space for housing the hoses, the internal portion of the growing baskets, and to permit the solution spray openings to provide plant nutrient solution to the internal portion of the growing baskets is described.

### BACKGROUND

### Field of Invention

The present disclosure relates to an aeroponic growing system and apparatus having a natural tree or shrub like appearance. The presently disclosed system will provide businesses and consumers with attractive alternatives to known aeroponic and hydroponic growing systems.

### Discussion of the Related Art

Today's aeroponic systems are all industrial in appearance with large unattractive metal or plastic structures that are not suitable for display but rather are hidden away from the end consumer of the foodstuffs grown. Systems supposedly intended for at home use appear more like a sterile environment found in food factories rather than a natural growing environment.

Known aeroponic and hydroponic growing systems can have circular, oblong and oval features but are still clearly man-made designs. The shapes and designs of currently known units are all designed with shapes, usually rectilinear, that do not exist in the natural environment.

The desire for aeroponic growing systems with a more natural organic look is of interest. The ability to grow fresh fruits and vegetables in a highly efficient manner in the exact same location as consumed would be of great interest to various groups of people including consumers and restaurateurs.

### SUMMARY OF THE DISCLOSURE

The present teachings are directed to aeroponic growing systems that include a reservoir base containing a reservoir for holding plant nutrient solution, at least one hose having a plurality of solution spray openings located thereon, a pump connected to the reservoir for holding plant nutrient solution and to one end of at least one hose, a plurality of growing baskets having both internal and external portions, a support structure comprising a plurality of growing basket openings, and sufficient internal space for housing the hoses, the internal portion of the growing baskets, and to permit the solution spray openings to provide plant nutrient solution to the internal portion of the growing baskets, and wherein the support structure comprises a non-rectilinear arboreal structure.

Also disclosed is a process for growing plants utilizing the aeroponic growing system described above and providing to that aeroponic growing system with a non-rectilinear arboreal structure at least one plant or other organic living item to the aeroponic growing system.

Further disclosed is an aeroponic growing system similar to the one described above having a reservoir base containing a reservoir for holding plant nutrient solution but having a differing number of hoses and an associated hose manifold with a differing number of hose receiving holes. Specifically, this embodiment of the system can have at least one hose having a plurality of solution spray openings located thereon and a hose manifold having at least one hose receiving hole, one end of each of the at least one hose connected to one of the at least one hose receiving hole.

The mimicking of appearance of a natural environment is just one of the features of the presently disclosed aeroponic growing systems which can have the appearance of being wholly and completely comprised of organic matter. The units will have the overall appearance of being natural plants, trees, or flora. The curving branches of the present system provide for internal areas for pooling of the plant nutrient solution. These internal pooling areas can provide solution to maintain humidity inside the system.

The systems can be composed of a base which will have the appearance of a pot or stand and can be a stabilizing base with the aeroponic pump unit, hose manifold and reservoirs for solutions housed therein and concealed from visibility. The pump or pumps, in some cases, will have inlets connected to the reservoirs, and outlets into which pliable and flexible hoses with openings will be inserted. The hose openings can dispense a nutrient rich solution directly on to the roots of the plants which can be contained in growing baskets which are affixed into the apertures of the limbs of the aeroponic unit which has the appearance of being an organic plant, tree or other flora. In some cases, there can be a hose manifold located after the pump and the reservoir in order to distribute the plant nutrient solution through the plurality of hoses connected to the manifold. The hoses are then fed up through the main branch of the arboreal apparatus and manipulated and affixed into the dispersing limbs of the arboreal unit with the openings being directed toward the baskets which house the seedlings of the organic vegetables or fruits. The opening in the hoses will then administer a timed spray of the nutrient rich solution into the base of the baskets where the seedlings are housed. The nutrient rich solution will then flow back down into the base of the unit by way of gravity for recirculation.

The aeroponic growing systems can be composed of trunks, branches, limbs, and other substrates made of materials, such as polyurethane, silicone, or composite materials to resemble natural plant limbs, trunks, and branches. Seedling baskets can be inserted into the numerous openings located throughout all of the afore-mentioned substrates of the unit. The growing basket openings in the trunks, branches, and limbs of the growing system housing the seedlings will over time flower and have the appearance of being the plant, fruit or other organic matter which has sprouted or flowered from the trunk, branches or limbs of the arboreal aeroponic growth unit. The vegetables, fruits and other organic plant material can then be harvested as and when appropriate.

In another embodiment of the presently disclosed aeroponic growing system, there is provided a non-rectilinear central structure with a plurality of non-rectilinear secondary elements connected to the central structure, and the central structure and each of the plurality of secondary elements have a contiguous hollow interior space. Located in one or both of the central structure and the secondary elements is a plurality of growing basket openings with a plurality of growing baskets located in each one of the plurality of growing basket openings. In the contiguous hollow interior space, at least one hose is located and it has a plurality of solution spray openings to provide plant nutrient solution to the growing baskets. The plant nutrient solution is held in a reservoir, a pump is fluidly connected to the reservoir for holding plant nutrient solution and to the hose.

This embodiment can further include a plurality of non-rectilinear tertiary elements connected to one or more of the secondary elements and can form a contiguous hollow interior space with the central structure and the secondary elements. A plurality of growing basket openings can be located in one or more of the plurality of tertiary elements which can, in turn, hold growing baskets and plants.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 illustrates a perspective view of the presently disclosed aeroponic growing system's reservoir base and main trunk, branches and limbs with growing basket openings;

FIG. 2 illustrates a perspective view of FIG. 1 with growing plants;

FIG. 3A illustrates a perspective view of another embodiment of the presently disclosed aeroponic growing system's trunk, branches and limbs;

FIG. 3B provides an exploded view of FIG. 3A;

FIG. 3C illustrates a perspective view of FIG. 3A with growing plants;

FIG. 4A is a perspective view of yet another embodiment of the presently disclosed aeroponic growing system;

FIG. 4B is a perspective view of FIG. 4A with growing plants and Christmas ornamentation;

FIG. 5A is an exploded view of another embodiment of a branch of the present disclosure;

FIG. 5B is an exploded view of another embodiment of a branch of the present disclosure;

FIG. 6A is a cross-sectional view of another embodiment of the aeroponic growing system;

FIG. 6B is a cross-sectional view of another embodiment of the aeroponic growing system;

FIG. 7A is a cross-sectional view of an embodiment of the aeroponic growing system;

FIG. 7B is a cross-sectional view of another embodiment of the presently disclosed aeroponic growing system, and

FIGS. 8A; 8B; 8C; and 8D are elevation views of more designs of the presently disclosed aeroponic growing system.

### DETAILED DESCRIPTION

In contrast to known aeroponic systems which are focused on maximizing the output of flora from a square foot of floor space, in various embodiments of the presently disclosed system, while high output of flora is important, the natural and appealing appearance of the presently disclosed aeroponic system is also important.

The present teachings include an aeroponic growing system constructed to mimic a natural, organic structure including any type of plant in contrast to existing aeroponic and hydroponic systems featuring rectilinear or unnatural design. Arboreal structure refers to a treelike structure. According to various embodiments of the present disclosure, trees that can be mimicked include any of the deciduous or coniferous trees, and further include bonsai trees and plants not typically classified as trees. Additionally, the presently disclosed aeroponic growing system can appear as a fancifully, imagined, “natural” structure. The shapes of the branches can be in various non-rectilinear forms including bending, curving, serpentine, meandering and sinuous.

The presently taught aeroponic growing system includes a reservoir base containing a reservoir for holding plant nutrient solution, at least one hose having a plurality of solution spray openings located thereon, a pump connected to the reservoir for holding plant nutrient solution and to the at least one hose, a plurality of growing baskets having both internal and external portions, a support structure comprising a plurality of growing basket openings, and sufficient internal space for housing the hose, the internal portion of the growing baskets, and to permit the solution spray openings to provide plant nutrient solution to the internal portion of the growing baskets, and the support structure having a non-rectilinear arboreal structure.

In some embodiments of the disclosed aeroponic growing system, instead of the at least one hose, there can be a hose manifold having a plurality of hose receiving holes, and a plurality of hoses. One end of each of the plurality of hoses can be connected to one of the plurality of hose receiving holes of the hose manifold.

Additionally, in some embodiments, the pump can be submerged in the reservoir for holding the plant nutrient solution, while in other embodiments the pump can be located outside of the reservoir in a dry location. Likewise, the hose manifold, if present, can be located out of the plant nutrient solution, or in some cases, can be submerged in the plant nutrient solution.

Specifically, the support structure has initial branching segments attached to a central trunk section in opposite, alternate, whorled, or random patterns. Then, on those central and/or branching segments there can be basket openings which can also be arranged in opposite, alternate, whorled, or random patterns. The support structure can be made to look like a naturally occurring known species of tree or bush, or can be structured in a more fanciful imaginative sense.

The support structure can be naturally colored to add to the overall appearance of a natural organic growing system. Non-porous material can be utilized to make the support structure, or when porous material is utilized the interior of the support structure can be lined, coated, or treated to be non-porous. It is preferable to keep the interior of the support structure and the root masses of the growing plants in an environment different from the surrounding environment, that is, typically a higher humidity environment due to the presence of the plant nutrient solution.

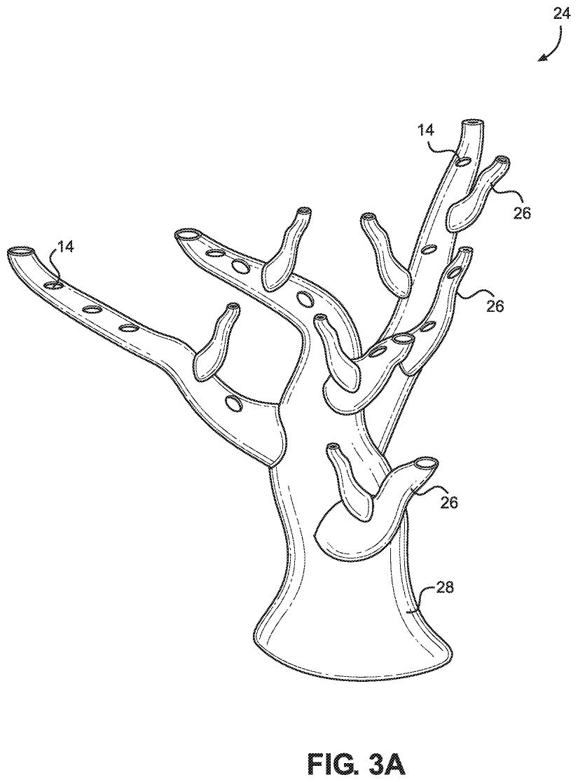

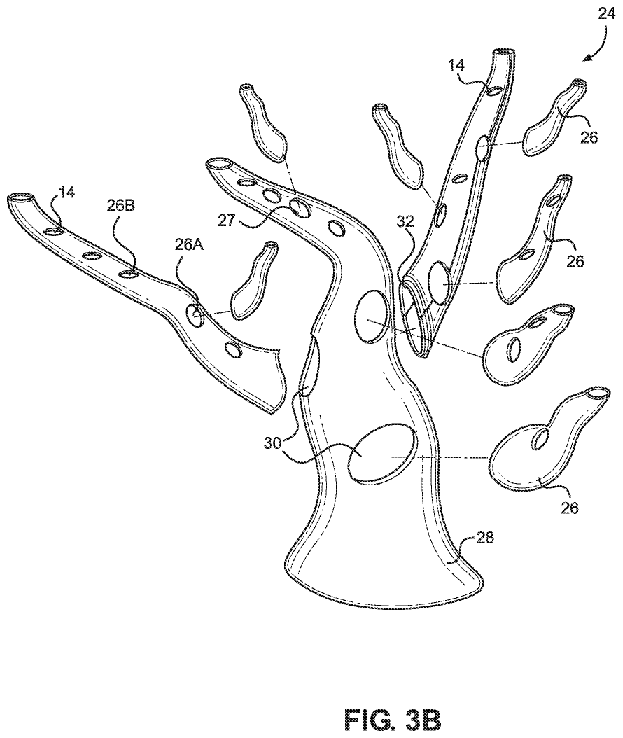

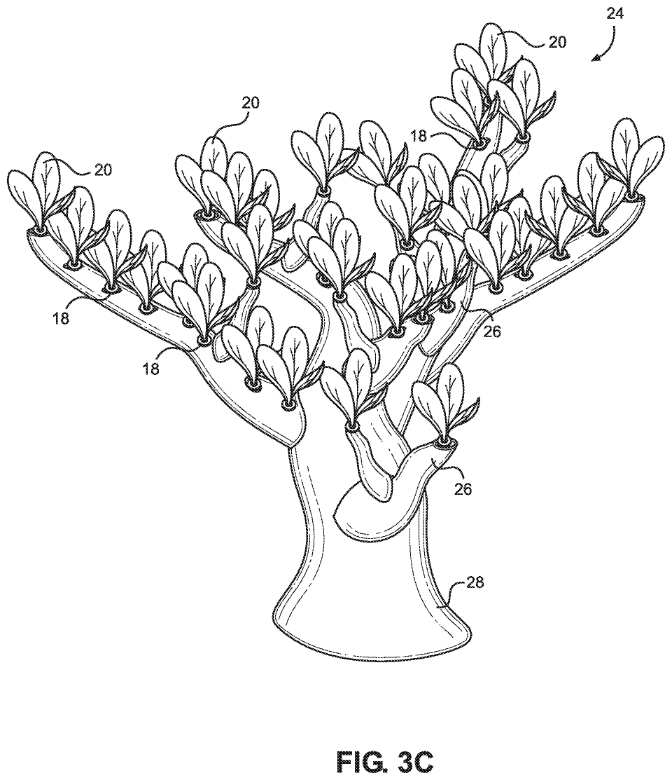

In some embodiments of the present aeroponic growing system, the support structure can be made in a one-piece unitary construction. The support structure can be constructed out of a suitable material that provides the physical strength and rigidity to hold the growing baskets and plants. As illustrated in FIG. 3B, the growing system can be composed of a central trunk 28 with inlets 26A, 26B and 30 for attaching the secondary limbs and branches 26. The secondary limbs and branches can have a ring structure 32 at one end to insert into the inlets 26A, 26B and 30 to provide a tight seal by a male and female connection.

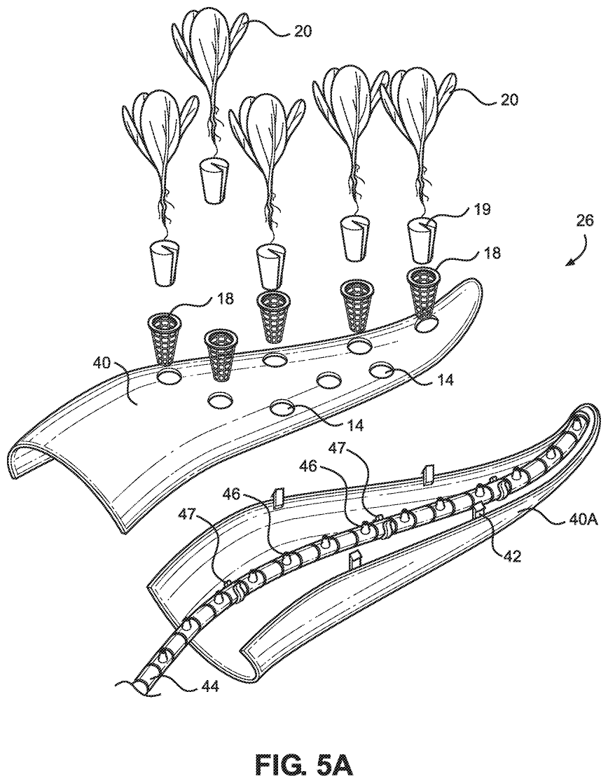

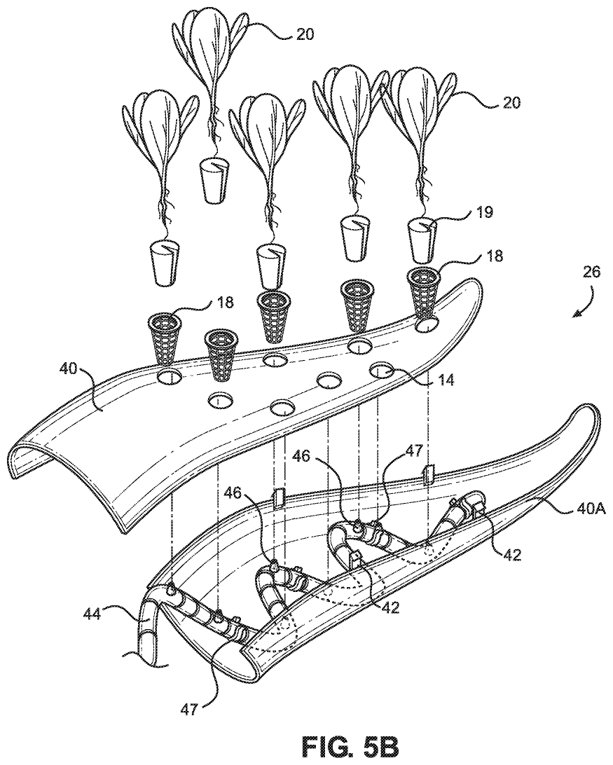

One embodiment of a way of construction of the secondary limbs and branches 26 is further shown in FIGS. 5A and 5B. The upper portion 40 can have numerous growing basket openings 14 to receive the growing baskets 18 which can contain growth medium 19 and plants 20. Tabs 42 can be present in the lower portion 38 and can be inserted in interior slots (not shown) inside top piece 40, or vice versa. The lower portion 38 can also have hose retaining clips 47 located at appropriate intervals to hold the hose 44 in the desired position.

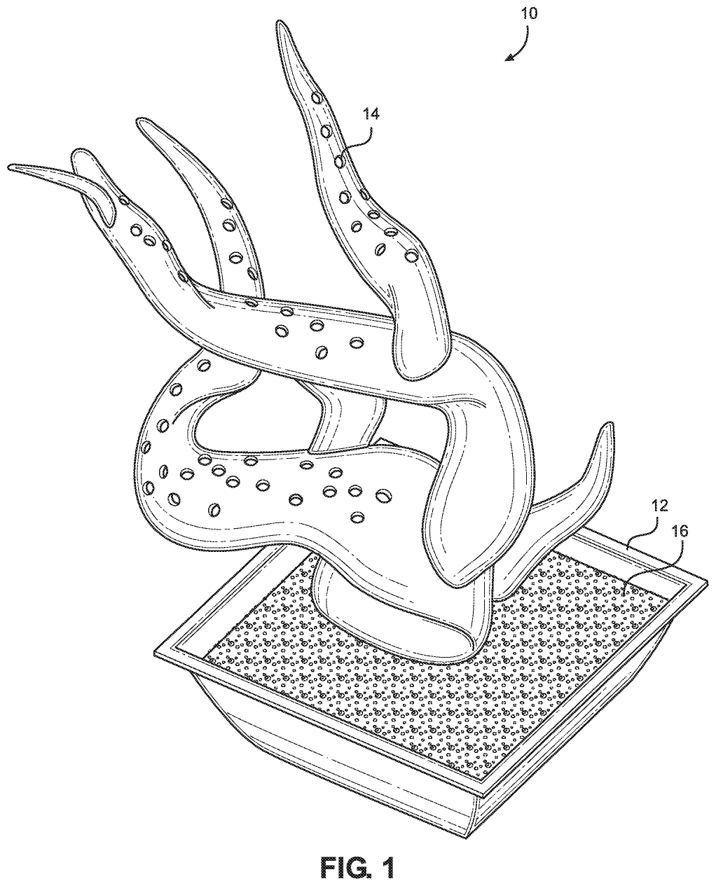

FIG. 5B presents a second expanded view of the branches of the aeroponic growing system of FIG. 1 with growing baskets 18 inserted into the growing basket openings 14, and plants 20 which are grown in both the tree branches and the base unit, respectively. In some instances, the hose 44 can be positioned by the hose retaining clips 47 so that the solution spray openings 46 can be positioned so that each opening supplies plant nutrient solution directly to one of the plants 20 growing inside one of the growing baskets 18.

The solution spray openings in the hoses can be one or more member selected from the group consisting of nozzles, perforated openings, spout heads, apertures, orifices, terminal element, and other liquid dispensing means. In the presently disclosed aeroponic growing system, each solution spray opening can be positioned to supply plant nutrient solution to one or more internal portions of the growing baskets, regardless of how the growing baskets are positioned, see FIG. 5B, or positioned in a generally straight line as shown in FIG. 5A.

In different embodiments of the present aeroponic growing system, the plurality of growing basket openings can be located in a straight line on support structure, or in other embodiments, can be located in a scattershot manner on the support structure. In some instances when a specific tree or bush is being modeled, then the growing basket openings can be in opposite, alternate or whorled configurations to mimic the natural arrangement.

The growing baskets 18 used in the presently taught aeroponic growing system can be insertable into and removable from the growing basket openings 14 in the support structure. The internal portion of the growing basket is the portion of the growing basket inside the internal space of the support structure. This internal portion contains the root mass of the plant being grown and is exposed to the output of the solution spray openings.

The plants 20 themselves can have their root mass encased in the growth medium 19 which can be composed of one of more elements selected from the group consisting of coconut grass, Spanish moss, sphagnum peat moss, perlite, vermiculite, composted bark, compost, and rockwool.

In some embodiments, the base section 12 can be further provided with a cover 16 containing suitable growth media such that a grass, moss, or other covering vegetation 22 can be grown. The growth media can be provided with the plant nutrient solution from the reservoir.

There can be more than one plant nutrient solution reservoir in the reservoir base along with more than one pump. The hose manifold can be arranged such that different plant nutrient solution reservoirs can be connected to different hoses of the plurality of hoses. In this way, different plants can be provided at different time intervals with different plant nutrient solutions depending on their specific needs. For instance, one branch of the presently disclosed aeroponic growing system can have butter lettuce in the growing baskets, while a different branch can have basil in the growing baskets, and each species can be provided with a different plant nutrient solution at the required time interval to provide optimum growth conditions for each species.

In some embodiments of the aeroponic growing system, sensors can be provided to monitor one of more of solution level and temperature in the reservoir for holding plant nutrient solution, humidity and temperature in the interior space of the support structure, and light exposure on the outer surface of the support structure. A connection to the internet from one or more of the sensors can be provided in some embodiments via Wi-Fi and/or Bluetooth.

Those sensor readings and others as needed can be provided to a computer or mobile phone-based application which can process the various readings to provide the user with notifications on adjustments to be made to the various parameters to increase the productivity or life of the growing plants.

Also disclosed in this present application is a process for growing plants by providing an aeroponic growing system with a non-rectilinear arboreal structure wherein the aeroponic growing system includes a reservoir base containing a reservoir for holding plant nutrient solution, a plurality of hoses having a plurality of solution spray openings located thereon, at least one hose having a plurality of solution spray openings located thereon, a pump connected to the reservoir for holding plant nutrient solution and to the at least one hose, a plurality of growing baskets having both internal and external portions, a support structure comprising a plurality of growing basket openings, and sufficient internal space for housing the hose, the internal portion of the growing baskets, and to permit the solution spray openings to provide plant nutrient solution to the internal portion of the growing baskets, and the support structure having a non-rectilinear arboreal structure, and providing at least one plant or other organic living item to the growing system, and harvesting the at least one plant at intermittent intervals as the plant grows.

In some embodiments of the disclosed plant growing process, in the aeroponic growing system, instead of the at least one hose, there can be a hose manifold having a plurality of hose receiving holes, and a plurality of hoses. One end of each of the plurality of hoses can be connected to one of the plurality of hose receiving holes of the hose manifold. The pump connected to the reservoir for holding plant nutrient solution can be connected to the hose manifold and can pump the solution through the plurality of hoses.

The type of plants that can be grown using this aeroponic growing system include, without limitation, vegetables including lettuces, spinach, kale, beans, peppers, cucumbers and peas, fruit including tomatoes and berries, and grains, grasses, herbs, moss, lichen, fungi, edible flowers, ornamental flowers, and medicinal marijuana.

Another step in the process is supplying plant nutrient solution to one or more internal portions of the growing baskets through the plurality of solution spray openings located on each of the hoses. As set forth above, a plurality of plant nutrient solutions can be held in a plurality of reservoirs, dispersed to the hose manifold, and then to the plurality of hoses to the growing baskets.

In some instances, the aeroponic growing system can have a switchable hose manifold which would allow for distribution of various solutions through the switchable hose manifold to a variety of hoses and hence to a variety of plants.

In some embodiments of the presently disclosed process, there can be monitoring of one or more solution levels and temperatures in the reservoir for holding plant nutrient solution, humidity and temperature in the interior space of the support structure, and light exposure on the outer surface of the support structure with sensors located in the aeroponic growing system. Suitable sensors include those known to one of skill in the art capable of measuring the desired parameters.

Further taught by the present disclosure is the use of mobile phone-based applications for receiving notifications when one of the sensors measures a value outside of pre-determined parameters. The pre-determined parameters can be set and changed via the application, in some cases, parameters can be set for both high and low levels of the property being detected by the sensors. For instance, measuring a low solution level in a reservoir holding a plant nutrient solution can be detected by a sensor and then relayed to the mobile phone-based application. Another example of the utility of the mobile phone-based application can be to provide the user notifications of the ideal harvesting time of the vegetation being grown on the taught embodiment.

The process can further include adjusting the supplying of plant nutrient solution depending on notifications received from the sensors. Other responses to the notifications can include, for example, adding additional plant nutrient solution, changing the formulation of the plant nutrient solution, adjusting the intensity and wavelength of light, adjusting the temperature of the aeroponic growing system, and adjusting the amount of plant nutrient solution provided to the growing baskets. In some embodiments of the system, the plant nutrient system can be water or water with added components such as fertilizers, stabilizers, inhibitors or other substances to promote growth or inhibit deleterious effects. It is preferred that any added components be organic.

Harvesting the individual plants at intermittent intervals as each plant grows is another step in the presently disclosed process. As described above, different living organisms can be grown and harvested in the growing baskets at differing time intervals as required by the characteristics of the organism (plants, mushrooms, etc.) In some instances, the growing baskets with the organisms inside can be grown in one location then moved to a different, perhaps more public location, when more fully grown. In this way, the public location will maintain a more vibrant appearance as opposed to baskets with very small seedlings. In other instances, growing baskets can be changed out to provide a differing variety of organisms present in one of the presently disclosed aeroponic growing systems.

There can be internal pooling 52 of the plant nutrient solution inside the branches of the aeroponic system, in contrast to known systems where the internal construction design is directed to complete return of the plant nutrient solution. The pooled solution can help to maintain a humid environment inside the system.

The arboreal appearance of the presently taught systems can provide the effect of appearing to be comprised of entirely organic matter, trees, and plants which also have the utility of growing vegetables, fruits, and other organic matter by way of aeroponic technology. The growing systems can be designed and manufactured to have the appearance of actual bonsai trees, miniature Christmas trees, marijuana plants, and other plants. The presently taught aeroponic growing systems are designed to be distinctive in appearance from any other aeroponic grow units. They can be manufactured from polymers, plastics, silicones, acrylics and other synthetically based materials yet still resemble natural tree or plant trunks and branches, and other organic matter, such as lichen, moss, vines, flowering vegetation, mushrooms etc.

The support structure for the presently disclosed aeroponic growing system can be constructed from a variety of suitable materials including polymeric membranes, silicones, plastic composites, molded plastics, fiberglass, and other composites. In some embodiments, if the support structure is not composed of a non-porous material, then the structure can be coated or lined, internally or externally, with a non-porous material to preserve a humid interior atmosphere.

In some embodiments of the present system, instead of hoses, the system can be molded or made by 3-D printing, to have voids inside the manufactured unit to carry the plant nutrient solution to the growing plants.

Large scale embodiments, or multiples of small-scale embodiments, of the presently disclosed aeroponic growing system can be used in restaurant, fast-food, and other dining establishments to provide patrons the opportunity to access on “premise-to-table” produce versus farm-to-table produce. The aeroponic growing systems can greatly increase efficiencies of provision and production of fresh produce in a visually appealing manner. The disclosed aeroponic growing systems can be produced to look like actual vegetation (bonsai trees, Christmas trees, marijuana plants, and other plants), in which and on which the homeowner or business owner can produce their own fresh produce. Additional design features such as small waterfalls, lighting, trickling streams and ponds can also be added to the aeroponic growing systems and in the case of restaurants and/or fast food businesses the embodiments size and scale may be magnitudes of order larger than those embodiments used by individual consumers.

In some embodiments, the pump, hose manifold and reservoir for holding plant nutrient solution can be of unitary construction with two or all three elements combined together.

FIG. 1 illustrates one embodiment of the presently disclosed aeroponic growing system 10 with a base unit 12 which houses pumps, reservoirs, and connected tubes (not shown) for storing and distributing plant nutrient solution. The base unit 12 can also be a stabilizing anchor for the growth unit and can be further provided with a cover containing suitable growth media 16 such that a grass, moss, or other covering vegetation can be grown. The branches have various growing basket openings 14. Here, a bonsai tree variant growing system is illustrated mimicking a specific species of plant.

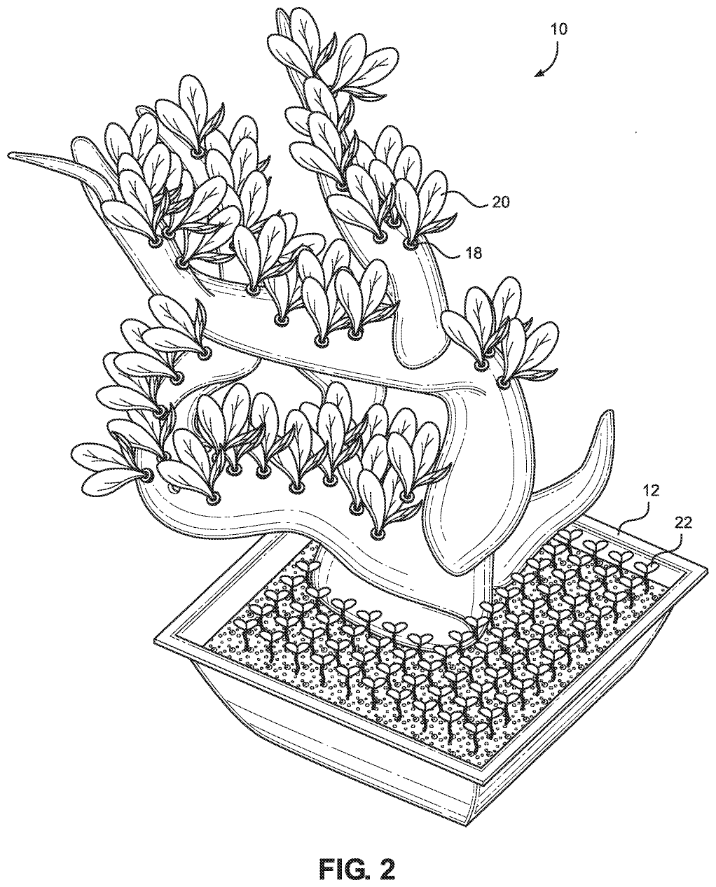

FIG. 2 presents a second view of the aeroponic growing system 10 of FIG. 1 with growing baskets 18 inserted into the growing basket openings 14, and plants 20 and 22 growing in both the tree branches and the base unit, respectively.

FIG. 3A provides a perspective view of a different embodiment of the presently disclosed aeroponic growing system 24, without a base unit 10. This growing system 24 is composed of a central trunk 28 with secondary limbs and branches 26. The secondary limbs and branches can have growing baskets openings 14. An exploded view of the system 24 is shown in FIG. 3B, and also in FIG. 3C with grown plants 20 in the growing baskets 18.

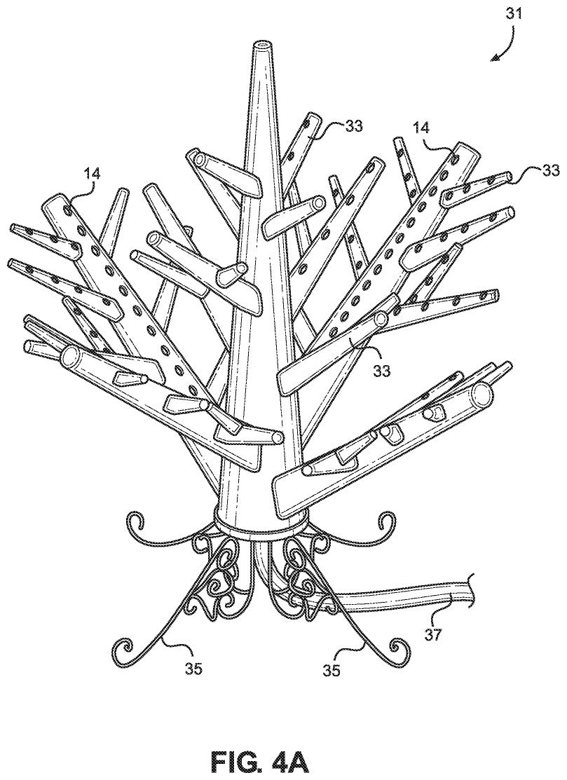

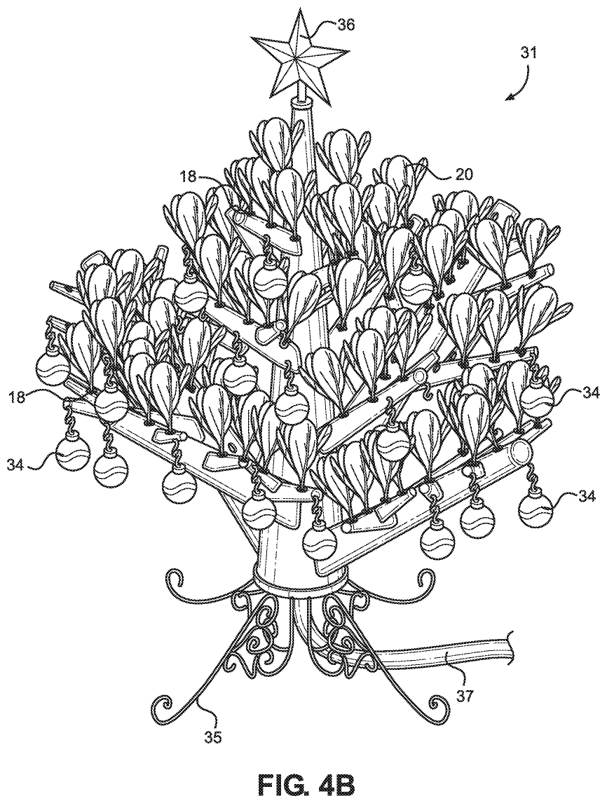

A perspective view of a yet another different embodiment 31 of the presently disclosed aeroponic growing system is represented at FIG. 4A and FIG. 4B, with support legs 35 with ornamentation 34 and 36 shown in FIG. 4B. The pump, manifold if present, and reservoir for plant nutrient solution (all not shown) are connected to the system by connecting hose 37 which contains the at least one hose supplying plant nutrient solution to the branches 33 as needed to grow vegetation 20. The individual vegetation plants 20 are inserted into growing baskets 18 which are, in turn, inserted into the growing basket openings 14. The growing baskets 18 can include growth medium 19 not shown.

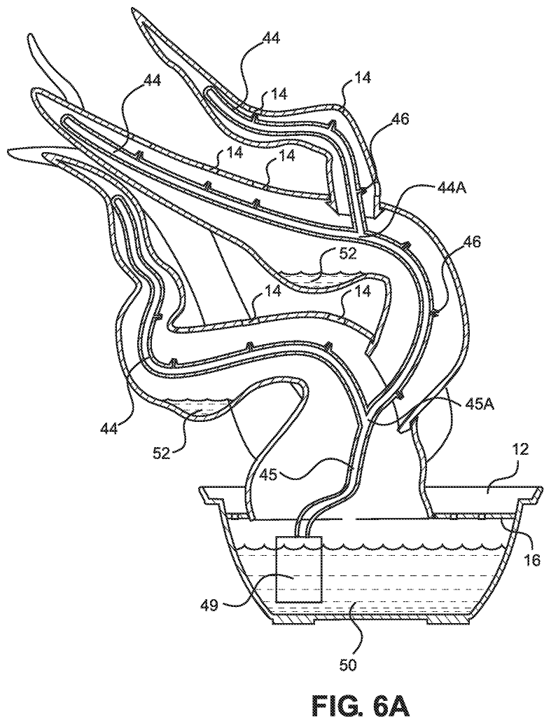

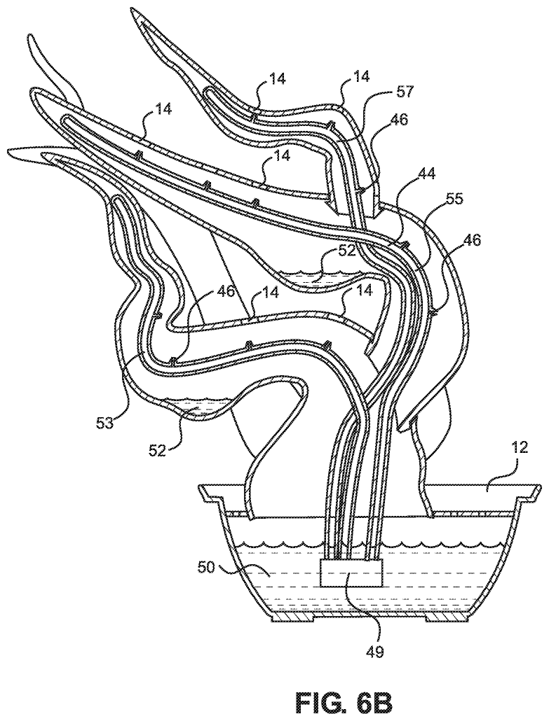

FIG. 6A illustrates the presently disclosed aeroponic growing system's base unit 12 which houses pumps 48, reservoirs 50, and connected tubes 45 for storing and providing plant nutrient solution. The base unit can also be a stabilizing anchor for the growth unit with its weight. The base unit can be further provided with a cover containing suitable growth media 16 such that a grass, moss, or other covering vegetation can be grown. The branches have various growing basket openings 14 according to an embodiment according to the present disclosure. As shown in FIG. 6A, hose 45 has multiple branches 44, and two Y-junctions 44A and 45A, that provide plant nutrient solution to all sections of the system. The hose 44 has spray nozzles 46 spaced along all its branches. The illustrated system has two pooling areas 52, where plant nutrient solution can collect and provide a source of humidity for the interior of the system.

Another embodiment of aeroponic growing system FIG. 1 is shown in cross-sectional view in FIG. 6B. Here, the submerged pump 48 is attached to a plurality of hoses 53, 55, and 57. Each hose extends into a separate branch of the system and has spray nozzles 46 located in designated areas to provide plant nutrient solution to their respective branch of the system. Pooling areas are present at 52. In some instances, the hoses can be tuned to provide appropriate amounts of plant nutrient solution to their respective branches by adjusting, among other things, the apertures of the manifold and spray nozzles.

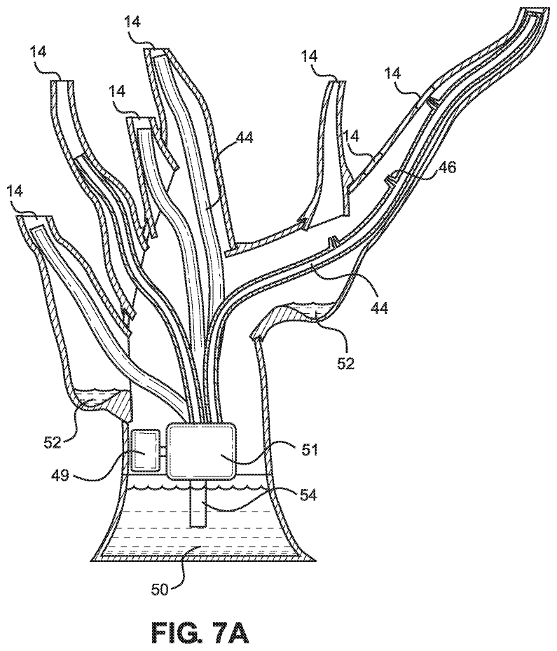

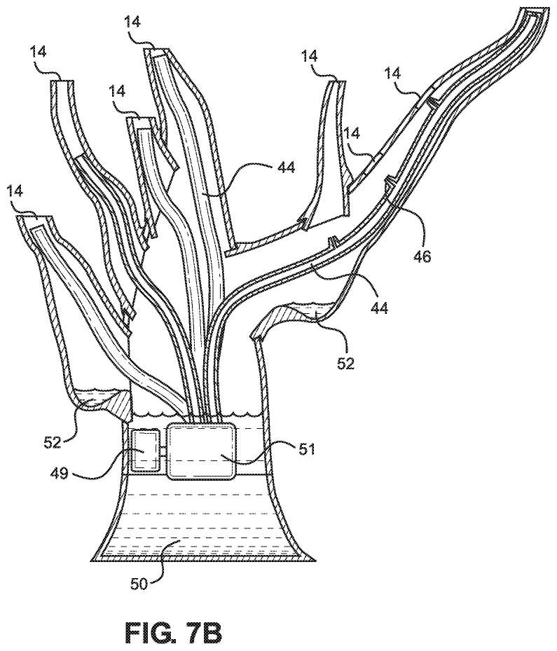

A perspective view of a different embodiment of the presently disclosed aeroponic growing system FIG. 1, without a separate base unit 12 shown, is shown in FIG. 7A. FIG. 7A details the pump 49 and the hose manifold 51 above the nutrient rich solution with a submerged hose 54. As shown, hose 54 supplies solution to the manifold 51 which then distributes solution to the multiple hoses 44 to provide plant nutrient solution to all sections of the system. The hoses 44, respectively have spray nozzles 46 (not shown for all hoses) spaced along their lengths.

FIG. 7B provides a cross-sectional view of the aeroponic growing system FIG. 1 showing pump 49 and the hose manifold 51 submerged in the plant nutrient solution 50 which then distributes the solution to the hoses 44. A hose 54 can optionally be present and submerged in the plant nutrient solution 50. The hoses 44, respectively have spray nozzles 46 (not shown for all hoses) spaced along their lengths.

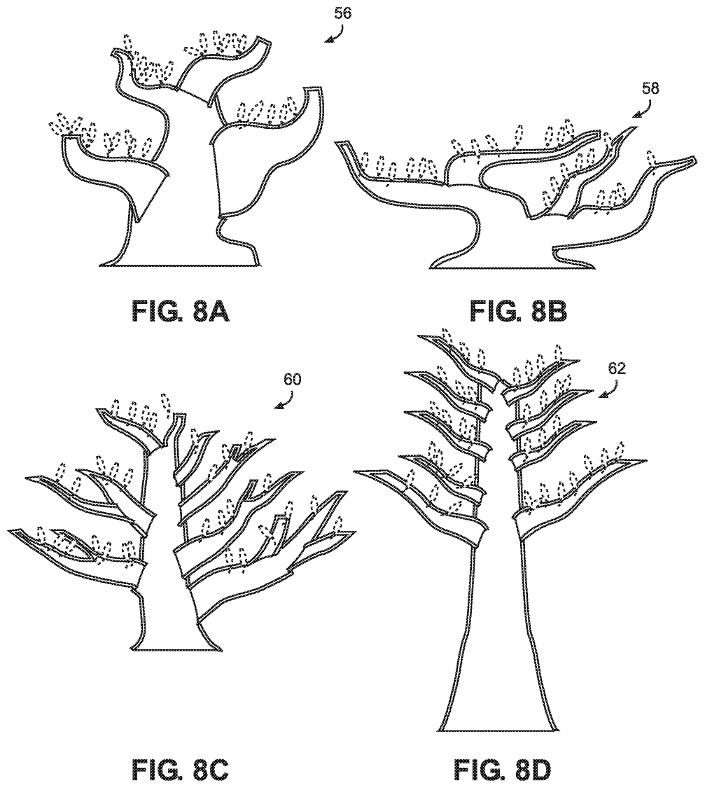

FIGS. 8A through 8D are representative views including cross-sectional views of various possible arrangements 56, 58, 60 and 62 of the presently disclosed aeroponic growing system. In some embodiments, the system is structured to mimic a specific species of tree or bush, and other embodiments are more fanciful in structure. In all cases, the aeroponic growing system is structured, covered or painted to mimic a natural growing plant.

In nature, tree and plant leaves on a stem can be found arranged in three general ways: opposite, alternate, and whorled. Opposite arrangement is when two leaves or branches originate from the same location on the stem or branch, and as a result are located opposite of each other. A subopposite arrangement can also occasionally occur when the leaves or branches are slightly offset instead of being truly opposite. Alternate arrangement is when each leaf or branch originates from a point on the stem or branch without another leaf or branch mirroring it, such that the leaves or branches are staggered along the stem or branch. The whorled pattern is when three or more leaves or branches originate from the same location on a stem or branch.

All publications, articles, papers, patents, patent publications, and other references cited herein are hereby incorporated by reference herein in their entireties for all purposes.

Although the foregoing description is directed to the preferred embodiments of the present teachings, it is noted that other variations and modifications will be apparent to those skilled in the art, and which may be made without departing from the spirit or scope of the present teachings.

The foregoing detailed description of the various embodiments of the present teachings has been provided for the purposes of illustration and description. It is not intended to be exhaustive or to limit the present teachings to the precise embodiments disclosed. Many modifications and variations will be apparent to practitioners skilled in this art. The embodiments were chosen and described in order to best explain the principles of the present teachings and their practical application, thereby enabling others skilled in the art to understand the present teachings for various embodiments and with various modifications as are suited to the particular use contemplated. It is intended that the scope of the present teachings be defined by the following claims and their equivalents.

What we claim is:

1. An aeroponic growing system comprising:
a reservoir base containing a reservoir for holding plant nutrient solution;
at least one hose having a plurality of solution spray openings located thereon;
a pump connected to the reservoir for holding plant nutrient solution and to the hose;
a plurality of growing baskets having both internal and external portions; and
a support structure comprising a plurality of growing basket openings, and sufficient internal space for housing the at least one hose, the internal portion of the growing baskets, and to permit the solution spray openings to provide plant nutrient solution to the internal portion of the growing baskets, wherein the support structure comprises a non-rectilinear arboreal structure.

2. The aeroponic growing system according to claim 1, wherein the support structure comprises branching segments attached to a central trunk section in opposite, alternate, whorled, or random patterns.

3. The aeroponic growing system according to claim 2, wherein the branching segments comprise growing basket openings which can be arranged in opposite, alternate, whorled, or random patterns.

4. The aeroponic growing system according to claim 1, further comprising a hose manifold connected to the pump, and having at least one hose receiving hole, one end of each of the at least one hose connected to one of the at least one hose receiving hole.

5. The aeroponic growing system according to claim 1, further comprising solution pooling areas located in interior curved portions of the arboreal structure.

6. The aeroponic growing system according to claim 1, wherein the solution spray openings comprise one or more members selected from the group consisting of nozzles, perforated openings, spout heads, apertures, orifices, terminal discharges, and other liquid dispensing means.

7. The aeroponic growing system according to claim 1, wherein the plurality of growing basket openings is located in a straight line on the support structure.

8. The aeroponic growing system according to claim 1, wherein the plurality of growing basket openings is located in a scattershot manner on the support structure.

9. The aeroponic growing system according to claim 1, wherein each solution spray opening of the plurality of solution spray openings is positioned to supply plant nutrient solution to one or more internal portions of the growing baskets.

10. The aeroponic growing system according to claim 1, wherein the growing baskets are insertable into and removable from the growing basket openings in the support structure.

11. The aeroponic growing system according to claim 1, wherein the internal portion of the growing basket comprises the portion of the growing basket inside the interior space of the support structure, containing the root mass, and exposed to the output of the solution spray openings.

12. The aeroponic growing system according to claim 1, further comprising sensors to monitor one of more of solution level and temperature in the reservoir for holding plant nutrient solution, humidity and temperature in the interior space of the support structure, and light exposure on the outer surface of the support structure.

13. The aeroponic growing system according to claim 12, further comprising a connection from one or more of the sensors to the internet.

14. The aeroponic growing system according to claim 1, wherein the pump is submerged in the reservoir for holding plant nutrient solution.

15. A process for growing plants comprising providing an aeroponic growing system with a non-rectilinear arboreal structure wherein the aeroponic growing system comprises:
a reservoir base containing a reservoir for holding plant nutrient solution;
at least one hose having a plurality of solution spray openings located thereon;
a pump connected to the reservoir for holding plant nutrient solution and to the hose;
a plurality of growing baskets having both internal and external portions;
a support structure comprising a plurality of growing basket openings, and sufficient internal space for housing the hoses, the internal portion of the growing baskets, and to permit the solution spray openings to provide plant nutrient solution to the internal portion of the growing baskets, and
providing at least one plant or other organic living item to the growing system, and harvesting the at least one plant at intermittent intervals as the plant grows.

16. The process according to claim 15, further comprising:
supplying plant nutrient solution to one or more internal portions of the growing baskets through the plurality of solution spray openings located on each of the hoses.

17. The process according to claim 15, further comprising:
monitoring one or more of solution level and temperature in the reservoir for holding plant nutrient solution, humidity and temperature in the interior space of the support structure, and light exposure on the outer surface of the support structure with sensors located in the aeroponic growing system.

18. The process according to claim 17, further comprising:
receiving a notification on a mobile phone-based application when one of the sensors measures a value outside of pre-determined parameters.

19. The process according to claim 17, further comprising:
adjusting the supplying of plant nutrient solution depending on notifications received from the sensors.

20. The process according to claim 17, further comprising receiving a notification on a mobile phone-based application when the solution level of the plant nutrient solution reaches a lower limit.

21. An aeroponic growing system comprising:
a non-rectilinear central structure;
a plurality of non-rectilinear secondary elements connected to the central structure;
the central structure and each of the plurality of secondary elements having a contiguous hollow interior space;
a plurality of growing basket openings located in one or both of the central structure and the secondary elements;
a plurality of growing baskets located in each one of the plurality of growing basket openings;
at least one hose located in the contiguous hollow interior space, the at least one hose having a plurality of solution spray openings to provide plant nutrient solution to the growing baskets;
a reservoir for holding plant nutrient solution, and
a pump fluidly connected to the reservoir for holding plant nutrient solution and the at least one hose.

22. The aeroponic growing system according to claim 21, further comprising:
a plurality of non-rectilinear tertiary elements connected to one or more of the secondary elements;
the central structure and each of the plurality of secondary and tertiary elements having a contiguous hollow interior space, and
a plurality of growing basket openings located in one or more of the plurality of tertiary elements.
